(19) United States
(12) Patent Application Publication
(10) Pub. No.: US 2024/0389494 A1
(43) Pub. Date: Nov. 28, 2024

(54) AUTOMATED STEERING BY MACHINE VISION

(71) Applicant: TOPCON POSITIONING SYSTEMS, INC., Livermore, CA (US)

(72) Inventors: Mikhail Yurievich VOROBIEV, Moscow (RU); Alexey Vladimirovich KALMYKOV, Moscow (RU); Nikita Andreevich KUTKIN, Moscow (RU)

(73) Assignee: TOPCON POSITIONING SYSTEMS, INC., Livermore, CA (US)

(21) Appl. No.: 18/691,625

(22) PCT Filed: Aug. 30, 2022
(86) PCT No.: PCT/RU2022/000261

§ 371 Date: Mar. 13, 2024

(51) Int. Cl. A01B 69/04; A01B 69/00

(52) U.S. Cl. CPC A01B 69/008; A01B 69/001

(57) ABSTRACT

A method for automated steering by machine vision receives a point cloud that is generated using a stereo camera. A location of a row is determined based on the point cloud and a steering angle is generated based on the location of the row. The center of the row is detected using a Hough transform detection algorithm and a horizontal projection of the point cloud.

### FIELD OF THE INVENTION

The subject matter of the present disclosure relates generally to machine automation and, in particular, to automated steering using machine vision.

### BACKGROUND

Agricultural machines typically require experienced operators in order to perform agricultural operations. Operations such as harvesting fruit in a vineyard or orchard require the operator to maintain travel of the vehicle parallel to a row of plants. Although some agricultural operations can be automated using global navigation satellite system (GNSS) hardware, the location of objects may not be known based on GNSS information alone. For example, the boundary of an orchard or vineyard may be known, but the actual location of the plants grown within the boundary may not be known. Further, growth of plants can be unpredictable in that branches may extend in various directions. What is needed is a method for automating agricultural equipment to perform operations on plants when the location of the plants is not known.

### SUMMARY

A method for automatic steering of an agricultural machine including the step of receiving, at a machine controller, point cloud data from a camera. A location of a row of plants is determined based on the point cloud data. A steering angle is generated for the agricultural machine based on the location of the row. In one embodiment, the determining comprises determining a centerline of a row based on a Hough transform detection algorithm. In one embodiment, the Hough transform detection algorithm determines the centerline of the row based on a horizontal projection of the point cloud data. In one embodiment, the horizontal projection of the point cloud is based on points of the point cloud that are higher than a ground plane found using a random sample consensus algorithm. The determining a centerline of the row is further based on a front projection of the point cloud. The steering angle can be generated further based on a heading error that is an angle between a longitudinal axis of the agricultural machine and a median line and, in some embodiments, an Xtrack that is a distance from the median line to a center of a rear wheel axis of the agricultural machine. In one embodiment, the median line is the centerline of the row. In another embodiment, the median line is a centerline located between the row and an adjacent row that is parallel to, and offset from, the row. An apparatus comprising a steering controller, a steering actuator, a camera, and a machine controller configured to perform operations for automated steering of an agricultural machine is also disclosed. A computer readable medium for automatic steering of an agricultural machine is also disclosed.

### BRIEF DESCRIPTION OF THE DRAWINGS

FIG. 1 shows a field having rows of plants located on either side of an alley;

FIG. 2 shows a tractor travelling down an alley;

FIG. 3 shows a harvester travelling along a row of plants;

FIG. 4A shows angle and height parameters of cameras attached to a tractor;

FIG. 4B shows angle and centerline to lens distance parameters of cameras attached to a tractor;

FIG. 4C shows angle parameters of cameras attached to a tractor;

FIG. 5A shows angle and height parameters of a camera attached to a harvester;

FIG. 5B shows angle and centerline to lens distance parameters of a camera attached to a harvester;

FIG. 5C shows an angle parameter of a camera attached to a harvester;

FIG. 6 shows heading and tracking parameters of a tractor travelling in an alley;

FIG. 7 shows heading and tracking parameters of a harvester travelling along a row;

FIG. 8 shows a point cloud of a row of plants;

FIG. 9 shows a point cloud of an alley bounded by a row on either side;

FIG. 10 shows a local coordinate system of a camera;

FIG. 11 shows a horizontal projection of a point cloud for row detection;

FIG. 12 shows a horizontal projection of a point cloud for alley detection;

FIG. 13 shows a point cloud front projection for use with a harvester;

FIG. 14 shows a graph having a line generated using median averaging based on the point cloud front projection of FIG. 13;

FIG. 15 shows a graph having curves generated using different averaging algorithms;

FIG. 16 shows a graph having various curves generated using different averaging algorithms;

FIG. 17 shows a flowchart of a method according to one embodiment;

FIG. 18 shows an automatic steering system according to an embodiment; and

FIG. 19 shows a high-level block diagram of a computer for performing operations of the components described herein according to an embodiment.

### DETAILED DESCRIPTION

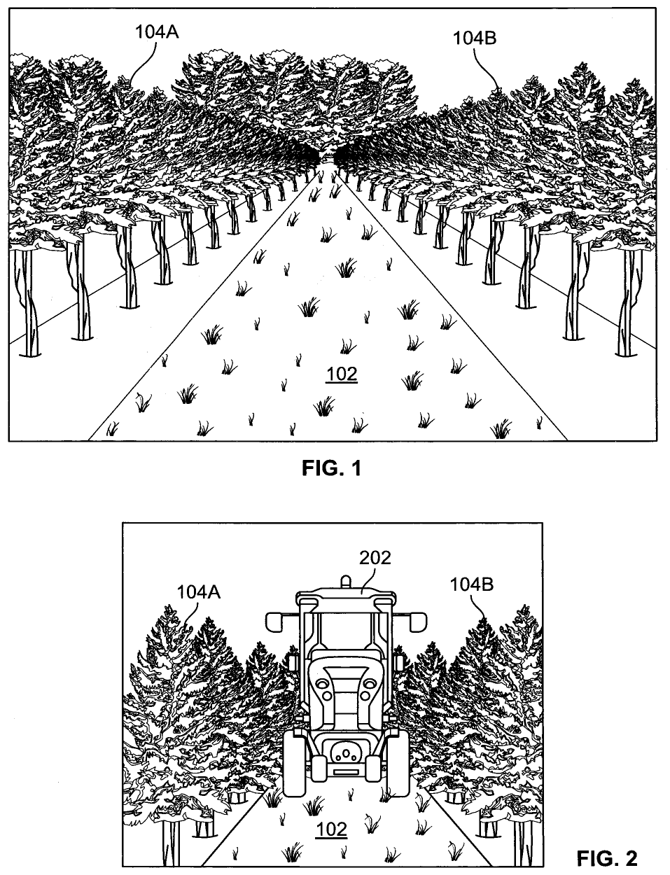

FIG. 1 shows an agricultural field having an alley 102 bounded on each side by rows 104A, 104B of plants. The plants of rows 104A, 104B require various agricultural operations to be performed in order to grow and harvest the plants from seeds to maturity. Machinery is frequently used to perform agricultural operations required to grow plants in the agricultural field.

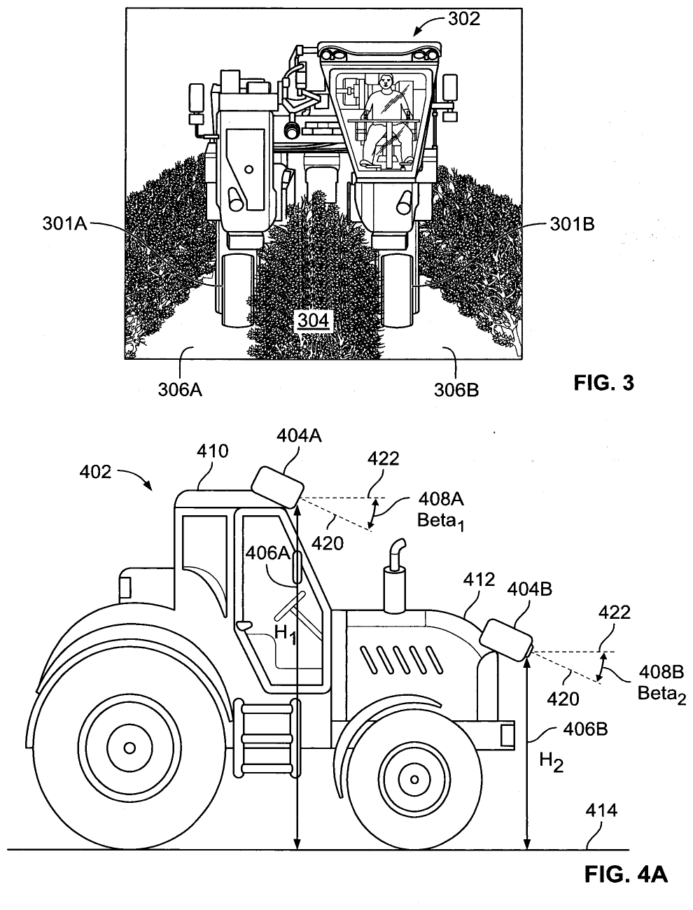

FIGS. 2 and 3 show agricultural machines that are controlled by an operator. FIG. 2 shows tractor 202 traveling along alley 102 bounded on each side by rows 104A, 104B. Tractor 202 is configured to travel along alley 102 without damaging plants of rows 104A, 104B located on either side of alley 102. FIG. 3 shows harvester 302 traveling along row 304. Wheel 301A of harvester 302 is shown travelling along alley 306A located on a first side of row 304 and wheel 301B is shown travelling along alley 306B located on a second side of row 304. Tractor 202 and harvester 302 generally travel at speeds of approximately 1-3 meters per second and the alleys between rows of plants typically have a width of 2-4 meters.

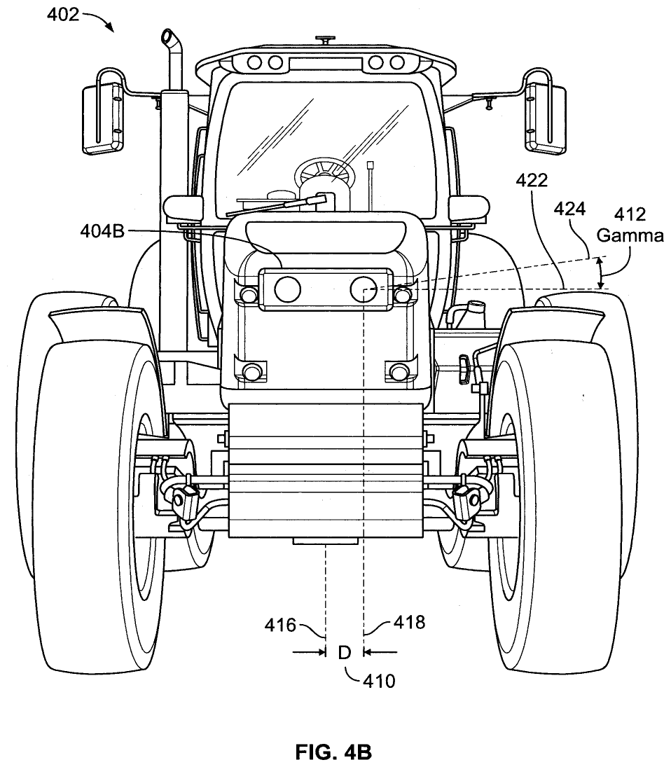

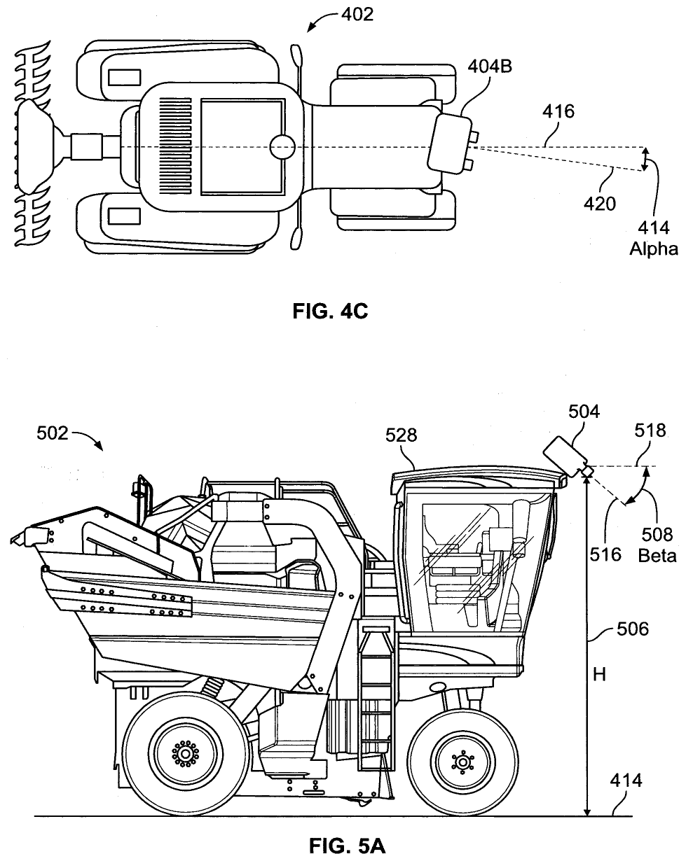

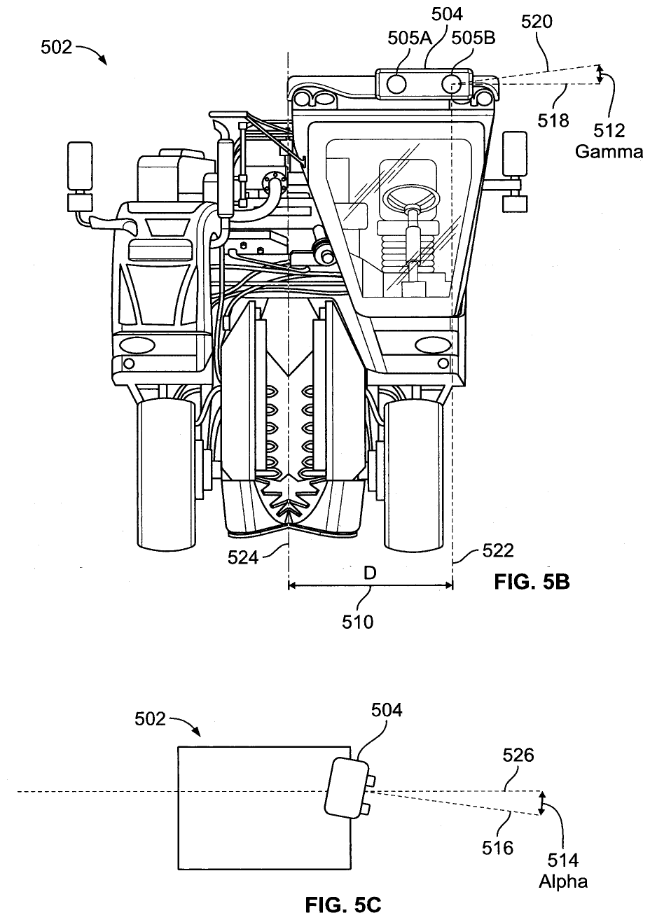

Automation allows for efficient and consistent operation of agricultural machines. In one embodiment, agricultural machines are automated using data from cameras that can be mounted to the machines. FIGS. 4A-4C and 5A-5C show orientation parameters of cameras that are based on how each camera is mounted to an associated vehicle.

FIG. 4A shows tractor 402 having camera 404A mounted on an upper body member (e.g., roof 410) and camera 404B mounted near the front of tractor 402 (e.g., hood 412). In one embodiment, cameras 404A, 404B are stereo cameras with each camera comprising two lenses. In other embodiments, cameras 404A, 404B can be any type of three-dimensional (3D) sensor such as a Time of Flight (ToF) camera or 3D LIDAR sensor. Camera 404A is located a height Hsub1 406A above ground 414 on which tractor 402 operates and camera 404B is located a height Hsub2 406B above ground 414 on which tractor 402 operates. Cameras 404A and 404B are both angled downward so that the field of view of each camera includes the area of ground 414 in front of tractor 402. In one embodiment, cameras 440A, 404B calculate a 3D point cloud of objects in each camera's respective field of view. Longitudinal axis 420 of camera 404A (i.e., the axis along which the camera views the environment) is angled downward from level 422 at angle betasub1 408A and longitudinal axis 420 camera 404B is angled downward from level 422 at angle betasub2 408B. It should be noted that angle betasub1 408A may be the same or different from angle betasub2 408B. It should be noted that one camera is sufficient for the operation of the system and FIG. 4A shows two options for the possible location of such a camera (i.e., the location of camera 404A and the location of camera 404B).

FIG. 4B shows additional orientation parameters of camera 404B. Offset D 410 is the offset of the center 418 of one of the two lenses of camera 404B from longitudinal centerline 416 of tractor 402. It should be noted that cameras 404A and 404B are mounted, in one embodiment, so that a point located between the two lenses of each of the cameras is located on the centerline of the machine on which the camera is mounted. Gamma 412 is the angle between level 422 and the lateral axis 424 of camera 404B based on how camera 404B is mounted.

FIG. 4C shows angle alpha 414 which is the angle between longitudinal axis 420 of camera 404B and longitudinal centerline 416 of tractor 402.

FIGS. 5A through 5C show orientation parameters of camera 504 mounted on an upper body member (e.g., roof 528) of harvester 502. FIG. 5A shows camera 504 located a height H 506 above ground 414 on which harvester 502 operates. Camera 504 is tilted downward at angle beta 508 so that its longitudinal axis 516 is lower than level 518. FIG. 5B shows offset D 510 which is the distance from center 522 of lens 505B of the camera from longitudinal centerline 524 harvester 502. FIG. 5B also shows angle gamma 512 which is the angle between level 518 and the lateral axis 520 of camera 504 based on how camera 504 is mounted. FIG. 5C shows angle alpha 514 which is the angle between longitudinal axis 516 of camera 504 and longitudinal centerline 526 of harvester 502.

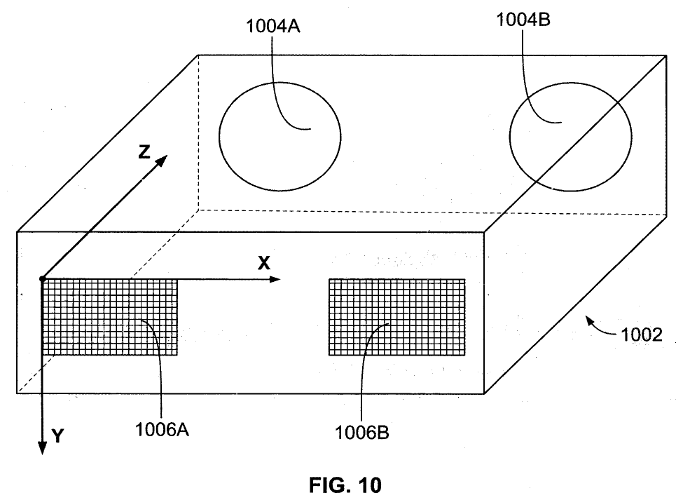

In one embodiment, offset D is based on the distance between a centerline of a vehicle and a projection to the ground of the origin of the local coordinate system of the stereo camera. In one embodiment, the origin is located in the upper-left corner of the camera's left sensor (see FIG. 10). Offset D, height H and one or more of the angles described above are used to link the vehicle's coordinate system to the camera's coordinate system.

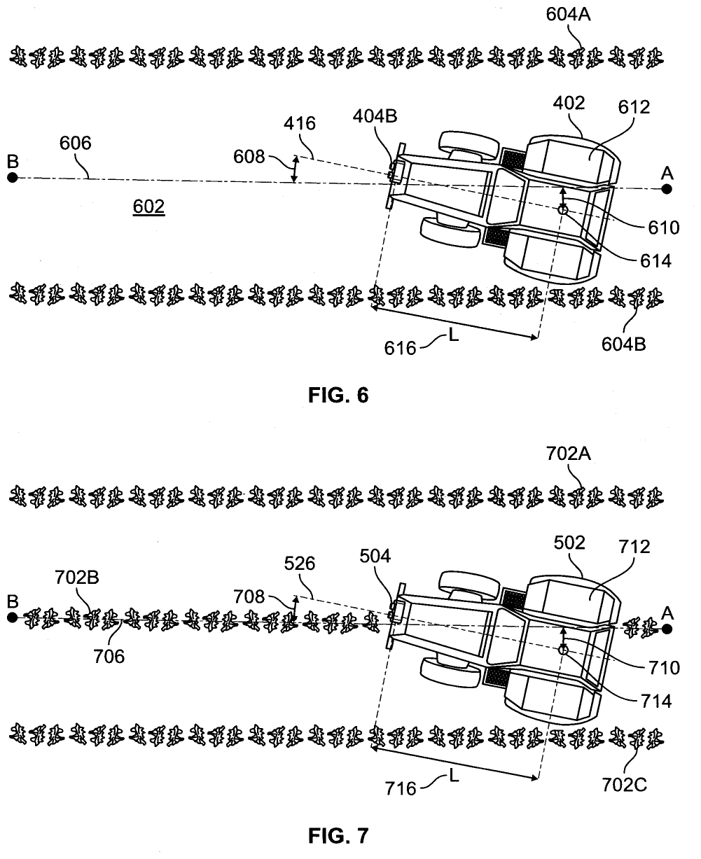

In one embodiment, orientation parameters of cameras on tractor 402 and harvester 502 are used together with a point cloud of data obtained using the cameras to steer tractor 402 and harvester 502 as described in detail below. Movement and orientation parameters of tractor 402 and harvester 502 are described in conjunction with FIGS. 6 and 7.

FIG. 6 shows tractor 402 travelling in alley 602 located between rows 604A, 604B of plants. Alley centerline 606 (also referred to as median line, vineyard alley center, or orchard alley center) is located substantially equidistant from rows 604A, 604B and is shown as a dashed line between points A and B. Heading error 608 is the angle between longitudinal axis 416 of tractor 402 and median line 606. Xtrack 610 is the distance from median line 606 to the center 614 of rear wheel axis 612 of tractor 402 (i.e., how far the longitudinal axis of the tractor is from the median line. For example, tractor 402 could be travelling parallel to median line 606 while its longitudinal centerline is not coincident with median line 606.). L 616 is the distance between camera 404B and rear wheel axis 612 of tractor 402.

FIG. 7 shows harvester 502 travelling between rows 702A, 702C and along row 702B. Centerline 706 of row 702B (also referred to as median line) is located along row 702B between points A and B. Heading error 708 is the angle between longitudinal axis 526 of harvester 502 and median line 706. Xtrack 710 is the distance from median line 706 to center 714 of rear wheel axis 712 of harvester 502. Distance L 716 is the. distance between camera 504 and center 714 of the rear wheel axis 712 of harvester 502.

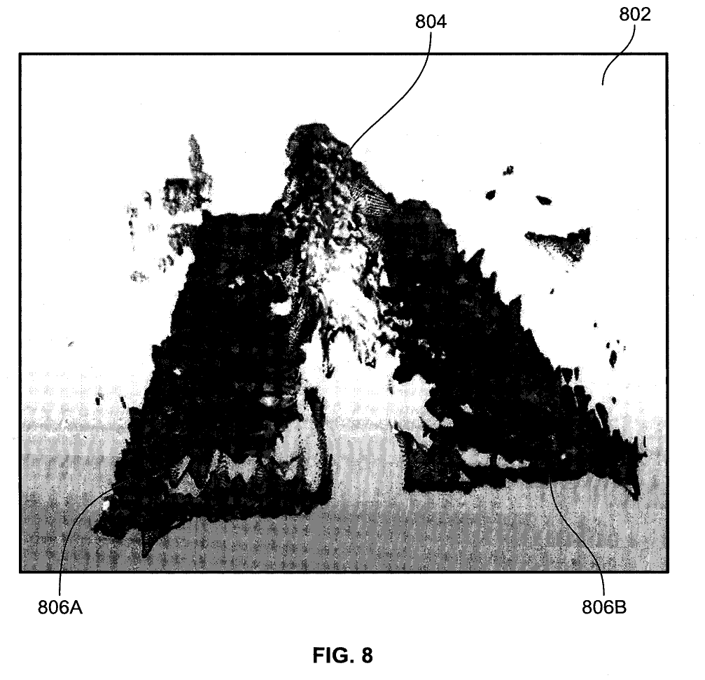

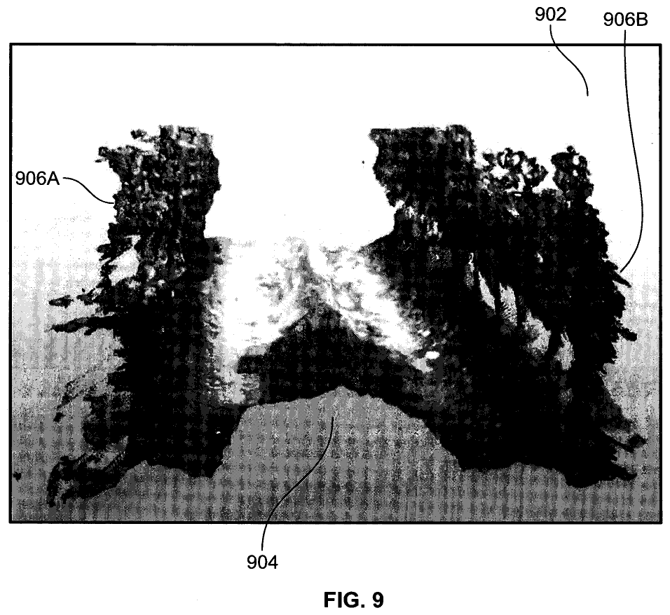

A camera (such as one of cameras 404A, 404B, and 504 shown in FIGS. 4A-4C, 5A-5C, 6, and 7) is used to generate point clouds of data pertaining to the environment in which tractor and/or harvester are operating. Point clouds of data comprise a plurality of points in 3D space where each point represents a portion of a physical object. In one embodiment, points of a point cloud are used to determine objects in the field of view of the camera. In one embodiment, point clouds 802,902 (shown in FIGS. 8 and 9 respectively) are used to determine the location of alleys and rows of plants with respect to an agricultural machine, such as tractor 402 or harvester 502. Point clouds are generated in real time as the agricultural vehicle associate with the camera moves or can be generated in advance of operations performed by vehicles.

FIG. 8 shows point cloud 802 including row 804 having alleys 806A, 806B located on either side. Point cloud 802, in one embodiment, is generated using data obtained from a camera (such as one of cameras 404A, 404B, and 504 shown in FIGS. 4A-4C, 5A-5C, 6, and 7). In one embodiment, point cloud 902 is generated based on information from camera 504 as harvester 502 travels along row 702B as shown in FIG. 7.

FIG. 9 shows point cloud 902 including alley 904 bounded on each side by rows 906A, 906B of plants. Point cloud 902, in one embodiment, is generated using data obtained from a camera (such as one of cameras 404A, 404B). In one embodiment, point cloud 802 shown in FIG. 8 is generated based on information from camera 504 as harvester 502 travels along vineyards row 706 as shown in FIG. 7.

In one embodiment, the coordinates of the cloud points are defined in a local coordinate system of a camera. FIG. 10 shows a local coordinate system of a camera according to an embodiment in which the coordinate system is based on an image sensor of a camera. Camera 1002 is shown having left lens 1004A and right lens 1004B. Each of the lenses focuses an image on a respective image sensor. Lens 1004A focuses an image on image sensor 1006A and lens 1004B focuses an image on image sensor 1006B. The coordinate system is located at point O where axes X, Y, and Z intersect. Point O, in one embodiment shown in FIG. 10, is located at the left upper corner of the left image sensor of the stereo camera. Horizontal axis X is orthogonal to vertical axis Y and both the X and Y axes lie in the plane of the left image sensor and they are orthogonal to axis Z.

In one embodiment, a ground plane coincident with a plane of the ground on which an agricultural machine travels can be found for a 3D point cloud using a random sample consensus (RANSAC) algorithm. Since the approximate position and orientation of the camera installation (height and inclination) are known, it is possible to impose restrictions on a desired plane, which can significantly speed up the search for the ground plane. As result, 3D sensor position and orientation relative to the ground plane can be estimated. Thus, sensor height, roll (lateral inclination) and pitch (longitudinal inclination) angles can be estimated.

In one embodiment, the point cloud that is obtained is transformed by translation and rotation using estimates of height, roll, and pitch angles of the camera in a manner so that the found ground plane is laying in the XOZ plane of the local coordinate system of the camera described above.

In one embodiment, a Hough transform detection algorithm is used to detect a centerline of rows of plants. For this algorithm, there are two modes of operation: a Harvester mode in which a camera is located above the row and only needs to detect a single row; and a Tractor mode in which a camera is located between rows and it is necessary to detect both rows from the left and right sides of the sensor.

In one embodiment, to find a row, a horizontal projection of the point cloud (top view) is used. When constructing the horizontal projection, only points located above the plane of the ground are used and the higher the point is located above the ground plane, the greater its contribution to the projection. Thus, on the horizontal projection, the rows are clearly visible, and the ground plane is removed.

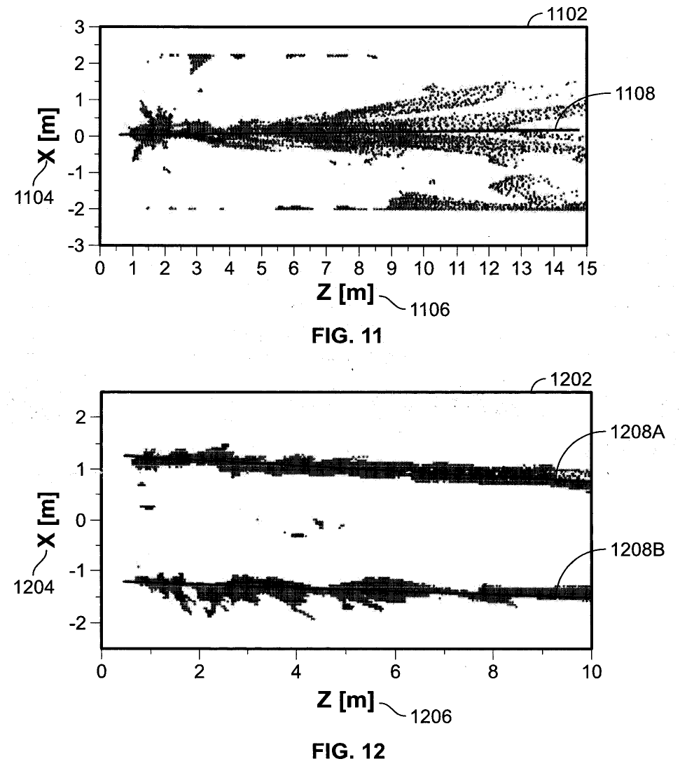

FIG. 11 shows horizontal projection 1102 for detecting the location of rows in order to control operation of a harvester with respect to the location of the rows of plants. A horizontal plane formed by X-axis 1104 and Z-axis 1106 (which represent the X-axis and Z-axis shown in FIG. 10, respectively) is used to show data of the point cloud that form a row. In one embodiment, a Hough transform detection algorithm is used to identify centerline 1108 of a row of plants.

FIG. 12 shows horizontal projection 1202 for detecting the location of rows in order to control operation of a tractor with respect to the location of the rows. Row detection for use with a tractor detects two rows that bound an alley. A horizontal plane formed by X-axis 1204 and Z-axis 1206 (which represent the X-axis and Z-axis shown in FIG. 10, respectively) is used to show data of the point cloud that forms two rows. In one embodiment, a Hough transform detection algorithm is used to identify centerlines 1208A, 1208B which each side of an alley.

The centerlines identified as shown in FIGS. 11 and 12 can be used to estimate heading error which is the angle between the longitudinal axis of a vehicle and the median line (i.e., the centerline of a row or an alley) and Xtrack.

A frontal projection of the point cloud is generated after compensating using the previously determined heading error which is determined based on the determination of the centerline of a row or the centerline of an alley between two rows.

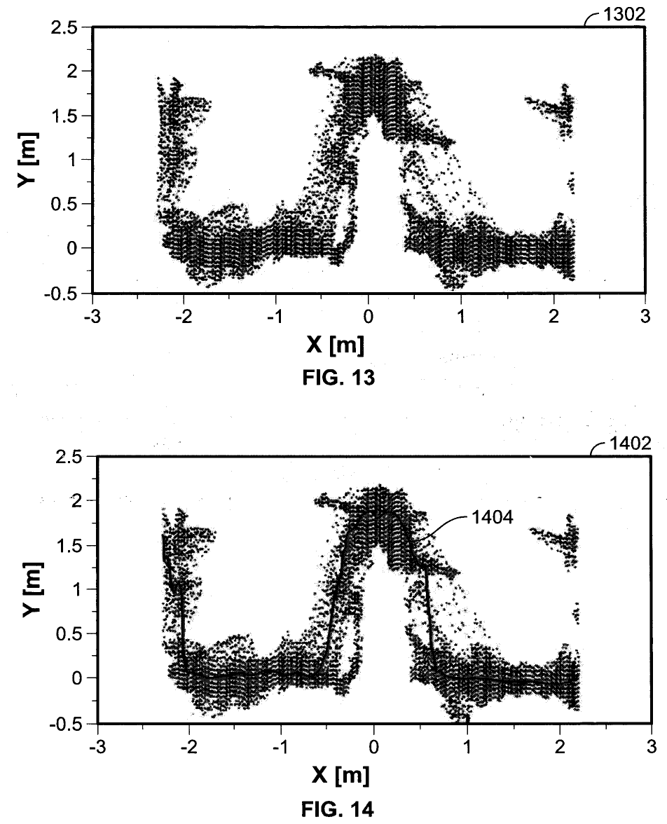

FIG. 13 shows point cloud front projection 1302 for use with a harvester. The X-axis and Y-axis shown in FIG. 13 correspond to the X-axis and Y-axis shown in FIG. 10, respectively. The point cloud front projection is averaged (i.e., the medians over the columns) in order to identify a peak of a row. FIG. 14 shows graph 1402 in which line 1404 is generated based on edge shape (i.e., median averaging).

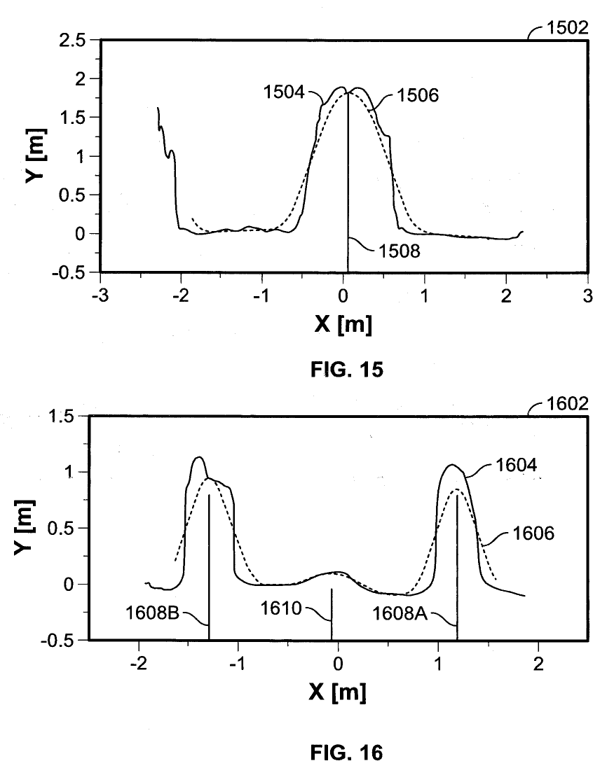

Using a sliding window averaging algorithm, a curve whose maximum value corresponds to the centerline of a row can be determined. FIG. 15 shows graph 1502 comprising various lines generated using different algorithms. Line 1504 is generated using median averaging (as shown in FIG. 14). Line 1506 is generated using sliding window averaging. Line 1508 shows a projection of maximum sliding window averaging function of the X-axis. Based on the data in FIG. 15, the lateral offset of a vehicle relative to a centerline of a row (i.e., the Xtrack) can be calculated based on the row centerline information and camera location information. Lines 1504, 1506, and 1508 are used to determine a centerline of a row. The information concerning the centerline of the row, along with vehicle orientation information, can be used to determine how a vehicle should be steered to traverse a desired path (i.e., along a centerline of a row for a harvester).

FIG. 16 shows graph 1602 comprising various lines generated using different algorithms. Graph 1602 is for use with a tractor and two rows are selected. Based on the two rows, a lateral bias for the tractor can be determined relative to the centerline between the two rows. Line 1604 is generated using median averaging (as shown in FIG. 14). Line 1606 is generated using sliding window averaging. Lines 1608A, 1608B show a projection of a maximum sliding window averaging function of the X-axis. Line 1610 is determined as being located midway between lines 1608A, 1608B. As such, lines 1604 and 1606 are used to determine lines 1608A and 1608B which are used to determine line 1610 (i.e., the centerline of an alley) which is located midway between lines 1608A and 1608B. The information concerning the centerline of the alley, along with vehicle orientation information, can be used to determine how a vehicle should be steered to traverse a desired path (i.e., along a centerline of an alley for a tractor).

In one embodiment, row detection can be more refined and exact. In some embodiments, the estimate of an alley obtained on the basis of the previous methods described above may not be accurate enough. This can be due to the fact that the row may contain vine branches that are significantly deflected to the side. To exclude such anomalies for the lane linear approximation, the least squares method is used.

Due to the density and accuracy of the 3D point cloud decreasing with distance from the stereo camera, and that higher points characterize rows better than lower points, in one embodiment, the least squares method is used taking into account the weight of measurement results. The closer and higher the point characterizing the row, the greater its weight.

In addition to estimating heading error and Xtrack based on a row, an estimate of the reliability of the results generated can also be calculated. The confidence level includes several criteria.

For the case of a harvester, there are three criteria: the continuity of the row, the immutability of the row's height, and the row's relative smoothness (i.e., how much the data points associated with the row differ from the approximating line).

For the case of a tractor, two more criteria are added: the parallelism of two adjacent rows and the correspondence of the distance between them to the expected value (the actual distance between rows on the field).

In one embodiment, the row, alley, and vehicle location information is used to implement vehicle steering commands. In one embodiment, the speed of the tractor is used to determine steering commands. Speed information can be obtained from the vehicle's standard odometry system or calculated using a navigation GNSS sensor. As an alternative method, the vehicle speed can be obtained with help of 3D optical sensor and the optical flow method.

In one embodiment, the Xtrack and heading error parameters based on vehicle location and row or alley location are used to generate a command for steering system. In one embodiment, the following formula is used:

U=−atan(L/V*(K1*ALPHA−K2*D)), where
U is steering angle for vehicle steering wheels in radians,
L is distance between front and rear wheel axles of the vehicle in meters,
V is vehicle speed in meters per second,
ALPHA is HEADING ERROR in radians,
D is XTRACK in meters,
K1 and K2 are scale factors.

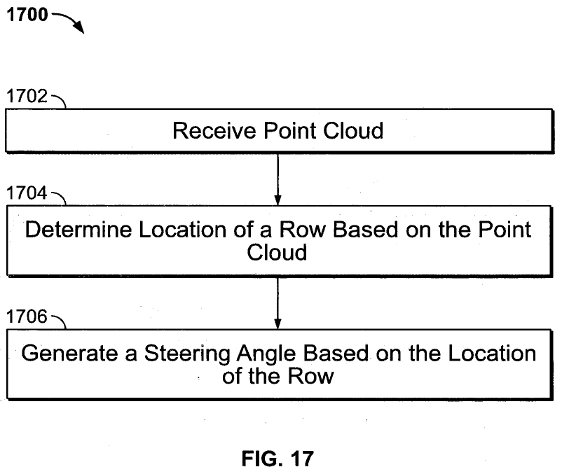

FIG. 17 shows a flowchart of a method 1700 for automatic steering of an agricultural vehicle. In one embodiment, a machine controller associated with an agricultural vehicle performs method 1700. At step 1702, a point cloud of data is received by the machine controller. In one embodiment, the point cloud is generated using a stereo camera mounted on the vehicle.

At step 1704, a location of a row is determined based on the point cloud. In one embodiment, the location of a row with respect to the vehicle is determined using steps previously described.

At step 1706, a steering angle is generated based on the location of the row with respect to the location of the vehicle. In one embodiment, the steering angle is generated based on a heading error and Xtrack determined based on the location of the vehicle with respect to the row. In one embodiment, the steering angle is determined using the formula described above.

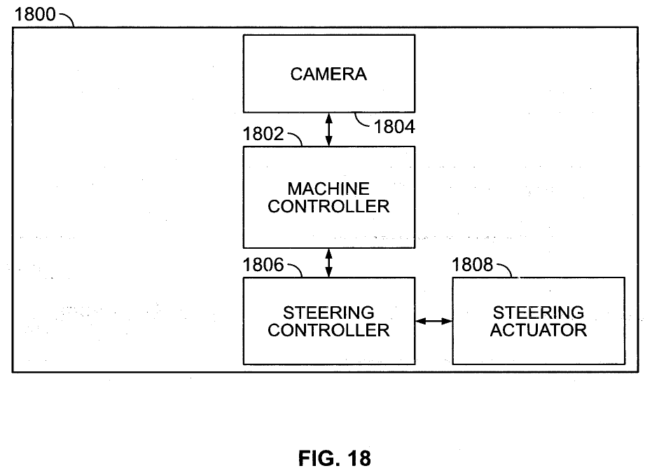

FIG. 18 shows automatic steering system 1800 comprising machine controller 1802 located on an agricultural vehicle that can be automatically steered. In one embodiment, machine controller 1802 is a processor and controls operation of the associated vehicle and, in some embodiments, additional peripherals. Machine control 1802 is in communication with camera 1804. In one embodiment, camera 1804 is one or more of cameras 404A, 404B, and 504 shown in FIGS. 4A-4C, 5A-5C, 6, and 7. Camera 1804, in one embodiment, transmits data that is used to generate a point cloud of data pertaining to objects in its field of view. In other embodiments, camera 1804 generates a point cloud of data that is transmitted to machine controller 1802. Machine controller 1802 is also in communication with steering controller 1806 which receives steering commands transmitted from machine controller 1802. Steering controller 1806 is in communication with steering actuator 1808 which steers agricultural vehicle when machine controller 1802 is operating to automatically steer the agricultural vehicle. Steering actuator 1808 can be an electric, hydraulic, or pneumatic device used to actuate steering linkage of a machine on which steering actuator 1808 is located. It should be noted that in some embodiments, the functionality of machine controller 1802, steering controller 1806, steering actuator 1808, and camera 1804 can be omitted or combined into one or more devices. For example, an agricultural machine may have a combination steering controller and actuator that performs the operations described herein as being performed by the machine controller, steering controller, and steering actuator. An agricultural machine may have a machine controller that performs the operations described herein as being performed by the machine controller, steering controller, and steering actuator.

In one embodiment, automatic steering system 1800 is calibrated after installation on an agricultural machine. Calibration may also be performed at other times as desired or as necessary. Calibration, in one embodiment, is performed by the agricultural vehicle travelling along a flat calibration surface having three straight reference lines while the machine controller is in a calibration mode. The reference lines are separated from each other by a known distance. Based on the information contained in the point cloud generated by the system while travelling along the flat calibration surface, automatic steering system 1800 can determine what adjustments are necessary in order for automatic steering system to operate correctly.

In one embodiment, the accuracy of Xtrack calculation is 5 centimeters or less and the accuracy of the heading error calculation is 1 degree or less. In one embodiment, the distance range for alley width calculations is 0.5 to 15 meters. In one embodiment, the distance between rows of plants in a field is substantially constant and is known.

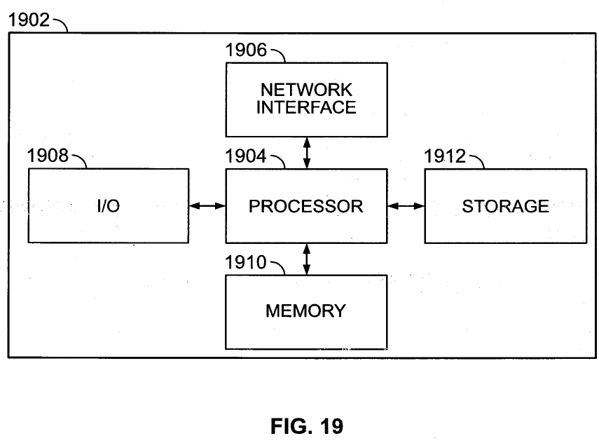

In one embodiment, a computer is used to implement machine controller 1802 that performs the method of FIG. 17. The computer, in one embodiment, is able to perform the method and provide a calculated steering angle at a rate of 5 Hz or greater. A computer may also be used to implement steering controller 1806, steering actuator 1808, and/or camera 1804. A high-level block diagram of such a computer is illustrated in FIG. 19. Computer 1902 contains a processor 1904 which controls the overall operation of the computer 1902 by executing computer program instructions which define such operation. The computer program instructions may be stored in a storage device 1912, or other computer readable medium (e.g., magnetic disk, CD ROM, etc.), and loaded into memory 1910 when execution of the computer program instructions is desired. Thus, the components and equations described herein can be defined by the computer program instructions stored in the memory 1910 and/or storage 1912 and controlled by the processor 1904 executing the computer program instructions. For example, the computer program instructions can be implemented as computer executable code programmed by one skilled in the art to perform an algorithm defined by the components and equations described herein. Accordingly, by executing the computer program instructions, the processor 1904 executes the method shown in FIG. 17. The computer 1902 also includes one or more network interfaces 1906 for communicating with other devices via a network. The computer 1902 also includes input/output devices 1908 that enable user interaction with the computer 1902 (e.g., display, keyboard, mouse, speakers, buttons, etc.) One skilled in the art will recognize that an implementation of an actual computer could contain other components as well, and that FIG. 19 is a high-level representation of some of the components of such a computer for illustrative purposes. In one embodiment, computer 1902 is implemented using an Nvidia Xavier or Orin processor.

The foregoing detailed description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for automatic steering of an agricultural machine comprising:
receiving point cloud data from a camera;
determining a location of a row of plants based on the point cloud data; and
generating a steering angle for the agricultural machine based on the location of the row.

2. The method of claim 1, wherein the determining comprises:
determining a centerline of the row based on a Hough transform detection algorithm.

3. The method of claim 2, wherein the Hough transform detection algorithm determines the centerline of the row based on a horizontal projection of the point cloud data.

4. The method of claim 3, wherein the horizontal projection of the point cloud data is based on points of the point cloud that are higher than a ground plane found using a random sample consensus algorithm.

5. The method of claim 4, wherein the determining the centerline of the row is further based on a front projection of the point cloud data.

6. The method of claim 1, wherein the generating a steering angle is further based on a heading error.

7. The method of claim 6, wherein the heading error is an angle between a longitudinal axis of the agricultural machine and a median line.

8. The method of claim 7, wherein the generating a steering angle is further based on an Xtrack.

9. The method of claim 8, wherein the Xtrack is a distance from the median line to a center of a rear wheel axis of the agricultural machine.

10. The method of claim 9, wherein the median line is a centerline of the row.

11. The method of claim 9, wherein the median line is a centerline located between the row and an adjacent row parallel to, and offset from, the row.

12. An apparatus comprising:
a steering actuator;
a camera; and
a steering controller in communication with the steering actuator and the camera, the steering controller configured to perform operations comprising:
receiving point cloud data from the camera;
determining a location of a row of plants based on the point cloud data; and
generating a steering angle for an agricultural machine based on the location of the row.

13. The apparatus of claim 12, wherein the determining comprises:
determining a centerline of the row based on a Hough transform detection algorithm.

14. The apparatus of claim 13, wherein the Hough transform detection algorithm determines the centerline of the row based on a horizontal projection of the point cloud data.

15. The apparatus of claim 14, wherein the horizontal projection of the point cloud data is based on points of the point cloud that are higher than a ground plane found using a random sample consensus algorithm.

16. The apparatus of claim 15, wherein the determining the centerline of the row is further based on a front projection of the point cloud data.

17. The apparatus of claim 12, wherein the generating a steering angle is further based on a heading error.

18. The apparatus of claim 17, wherein the generating a steering angle is further based on an Xtrack.

19. A computer readable medium storing computer program instructions for automatic steering of an agricultural machine, which, when executed on a processor, cause the processor to perform operations comprising:
receiving point cloud data from a camera;
determining a location of a row of plants based on the point cloud data; and
generating a steering angle for the agricultural machine based on the location of the row.

20. The computer readable medium of claim 19, wherein the determining comprises:
determining a centerline of the row based on a Hough transform detection algorithm.

21. The computer readable medium of claim 20, wherein the Hough transform detection algorithm determines the centerline of the row based on a horizontal projection of the point cloud data.

22. The computer readable medium of claim 21, wherein the horizontal projection of the point cloud data is based on points of the point cloud that are higher than a ground plane found using a random sample consensus algorithm.

23. The computer readable medium of claim 22, wherein the determining the centerline of the row is further based on a front projection of the point cloud data.

24. The computer readable medium of claim 19, wherein the generating a steering angle is further based on a heading error.

25. The computer readable medium of claim 24, wherein the generating a steering angle is further based on an Xtrack.
